(19) United States
(12) Patent Application Publication
(10) Pub. No.: US 2020/0178514 A1
(43) Pub. Date: Jun. 11, 2020

(54) Snap Trap Sheild

(71) Applicant: David B Schurman, Conway, NH (US)

(72) Inventor: David B Schurman, Conway, NH (US)

(21) Appl. No.: 16/304,687

(22) PCT Filed: May 26, 2017
(86) PCT No.: PCT/US2017/034724

§ 371 Date: Nov. 26, 2018

Related U.S. Application Data
(60) Provisional application No. 62/392,323, filed on May 27, 2016.

(51) Int. Cl. A01M 23/30; A01M 23/16

(52) U.S. Cl. CPC A01M 23/30; A01M 23/245; A01M 23/16

(57) ABSTRACT

An improved, humane mousetrap apparatus is contemplated. The mousetrap apparatus having a trap, the trap having a base, a striking bar, a retaining bar, and a trigger, an inner housing having an access opening, positioning tabs, and securing tabs and an outer housing having an access opening, a pocket, and at least four walls, the apparatus retaining a mouse in a position for the striking bar to strike the rodent in the head or neck.

This application is a national stage application of PCT/US17/34724 with international filing date 26 May 2017 which claimed the benefit of provisional application No. 62/392,323 filed 27 May 2016.

### FIELD OF THE INVENTION

The present invention generally relates to an adaptation mouse traps and pest control devices.

### BACKGROUND

There is currently no humane and effective way to get mice (rats, etc) out of a building. Thus, there is a need for changing the methods that are safe and effective for rodent removal.

The present disclosure pertains to traditional wooden framed snap traps which. As the trap is available in sizes for mice and rats, any reference to mice can also be taken to apply to rats or other rodents. The principles put forth in this writing can also apply to other styles of snap traps however the traditional wooden frame snap trap is illustrative for the purposes of explaining the working mechanisms and operation of this invention.

While there are other alternatives available for mouse removal they all have readily apparent downsides. Poison is dangerous for pets and children. Pets can accidentally eat the poison, or can be poisoned by catching and eating the mouse after it is poisoned because it is sick and slow moving. The mouse suffers a slow death and dies in the walls or ceiling and starts to smell. It is easy to forget poison that has been set out and pets or children can get into it years later.

Glue traps are very cruel and leave the mouse to suffer for a long time before it dies of dehydration or stress. In addition, glue traps commonly catch non-pest animals such as birds, frogs, pets, etc, often resulting in fatal, or harmful encounters.

Electronic traps are expensive and unreliable, which will prevent their wide spread use. They require that the batteries be kept up with and there are many reports of ineffective operation. Mice have a tendency to be reluctant to go deeply into a confined space that is required by an electronic trap.

Perhaps the cruelest trap of all is the one that you would think is the most humane. The live catch and release trap is kind to mice when you catch them but the problem is that there is no good place to release them. If they are too close to home they will come right back. When taking them to wild places they will be killed by the mice that live in that territory or by predators. In the winter they will freeze to death. The house mouse has no ability to live in the wild and it will be terrified and it will not survive.

Thus, many people continue to use the traditional wooden framed snap trap (or similar snapping devices). They are fairly effective, humane, and inexpensive. However, they still have major shortcomings discussed herein.

### BRIEF SUMMARY

The traditional trap (snap trap) is the best way to rid a building of mice because it is inexpensive so multiple traps are practical and it is effective and humane when the mouse is struck in the head or neck and killed instantly. The trap however has major shortcomings.

A major problem with the trap that it allows the mouse to approach the bait from any direction letting the striking bar hit and trap the mouse by any part of its body causing the mouse to possibly suffer a slow death or even be able to drag the trap away. In addition, the mouse can see the retaining bar that is right in front of its eyes when it is eating the bait. When the trigger mechanism is activated and the retaining bar starts to move the mouse is startled and it jumps back escaping the striking bar. It is a further problem with the trap that often the trigger mechanism is not activated by the mouse sometimes allowing the mouse to eat all the bait without triggering the trap. Possibly the most troubling problem with the standard snap trap is that that the trap mechanism is exposed so that pets and children (or even a careless adult) can activate the trap thus causing injury.

Thus, the present disclosure is directed towards alleviating the shortcomings of the trap.

The invention of the present disclosure is intended to be used with the trap to improve its function in killing a mouse humanely and efficiently. It is designed to force the mouse to align its head in such a way that the striking bar of the trap will hit the mouse in the head or neck and kill it instantly to prevent the mouse from suffering. It is also intended to prevent the mouse from seeing the retaining bar of the trap start to move when the trigger mechanism is activated thus keeping the mouse from being startled and jumping back upon seeing this movement and escaping the trap. It will also generally cause the mouse to force its mouth into a confined space between the trigger mechanism holding the bait and the top of an inner housing in order to reach the bait thus causing the trigger mechanism to be activated more reliably. Further, the present disclosure covers the trap so that children and pets cannot accidently trigger the trap.

The present disclosure, an improvement to the snap trap mouse trap consists of two parts in addition to the trap itself, an outer housing and an inner housing. The outer housing fits over the trap completely enclosing it except for an access opening in the front adjacent to the trigger mechanism of the trap so the mouse can only access the trap through this opening. The inner housing is locked into the outer housing thus positioning it precisely over the trigger mechanism of the trap. The inner housing prevents the mouse from going too far onto the trap. The inner housing also blocks the mouse from seeing the movement of the trap when it is sprung. The inner housing also forces the mouse to push it nose into a confined space to get the bait thus triggering the trap more efficiently.

The advantages of such an application become clear when one is experienced in mousetraps and pest control devices. Typical devices currently on the market do not have the confluence and plethora of features contemplated and described herein.

A first embodiment contemplates a mousetrap apparatus composed of a trap, the trap having a base, a striking bar, a retaining bar, and a trigger; an inner housing having an access opening, positioning tabs, and securing tabs; and an outer housing having an access opening, a pocket, and at least four walls and a top.

In a second embodiment the present disclosure contemplates a mousetrap cover composed of an outer housing having a front wall, a back wall, and two side walls, an access opening located centrally on the front wall, and positioning notches; and an inner housing having an access opening, positioning tabs, and securing tabs, the access opening of the inner housing positioned within the access opening of the outer housing.

In another embodiment the disclosure contemplates a method of dispatching rodents, the method composed of providing a trap, and inner housing and an outer housing, the trap having a base, a striking bar, a retaining bar, and a trigger, the inner housing having an access opening, positioning tabs, and securing tabs, and the outer housing having an access opening, a pocket, and at least four walls; baiting the trap with a bait; positioning the inner housing over the trigger; positioning the outer housing over the inner housing and trap; admitting a rodent through the access opening of the outer housing into the access opening of the inner housing; and triggering the trigger, causing the retaining bar to move and the striking bar to strike thereby dispatching the rodent.

Such embodiments do not represent the full scope of the invention. Reference is made therefore to the claims herein for interpreting the full scope of the invention. Other objects of the present invention, as well as particular features, elements, and advantages thereof, will be elucidated or become apparent from, the following description and the accompanying drawing figures.

### DESCRIPTION OF THE DRAWINGS

The present invention may be better understood, and its numerous objects, features, and advantages made apparent to those skilled in the art by referencing the accompanying drawings.

FIG. 1 is a perspective view of snap trap according to the present disclosure.

FIG. 2 is a side on view of a snap trap, cover, and exemplary rodent according to the present disclosure.

FIG. 3 is an exploded view of a snap trap, and cover according to the present disclosure.

FIG. 3a is a close up exploded view of the inner and outer cover of the present disclosure.

FIG. 3b is a close up exploded view of the inner and outer cover of the present disclosure.

FIG. 3c is a close up exploded view of the inner and outer cover with notches of the present disclosure.

FIG. 4 is a perspective view of the improved snap trap apparatus according to the present disclosure.

FIG. 5 is a side on view of the apparatus according to the present disclosure in a first state.

FIG. 6 is a side on view of the apparatus according to the present disclosure in a second state.

FIG. 7 is a perspective view of a portion of the apparatus showing the relationship between the inner housing, the inner housing partial back wall and the trigger mechanism of the apparatus of the present disclosure.

### DETAILED DESCRIPTION

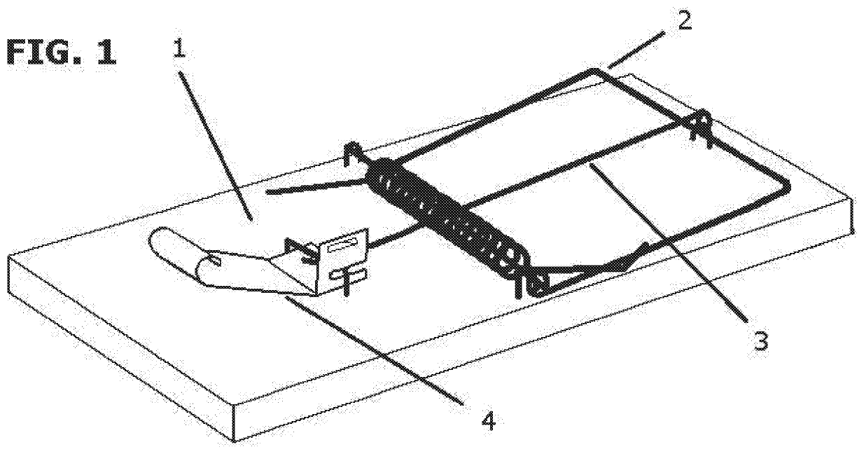

Referring now the drawings with more specificity, the present invention essentially provides a mousetrap and improved mousetrap cover. The preferred embodiments of the present invention will now be described with reference to FIGS. 1-7 of the drawings. Variations and embodiments contained herein will become apparent in light of the following descriptions.

Looking to FIG. 1 a mousetrap 1 is shown. A mousetrap 1 is composed of a striking bar 2, retaining bar 3, trigger mechanism 4 and can optionally be outfitted with bait 15. Operation of mousetrap 1 is similar to conventional snap traps and such snap traps can be used with the invention of the present disclosure.

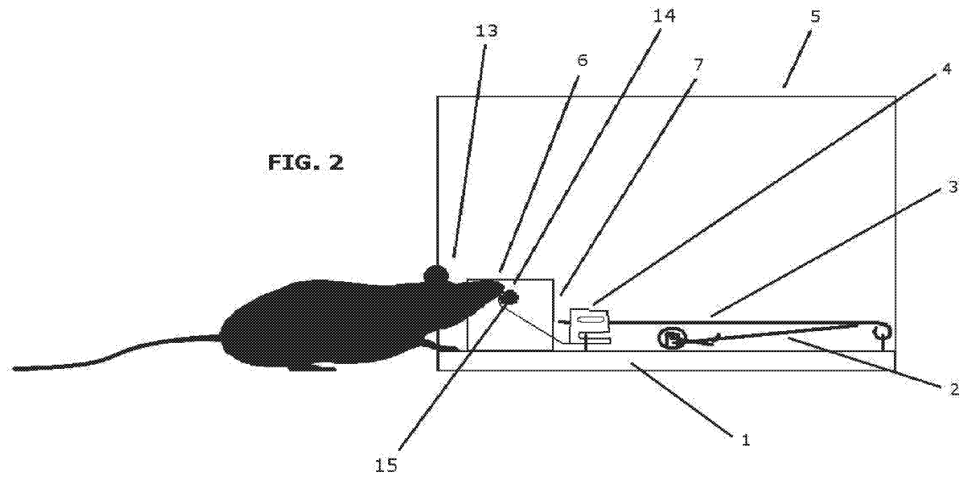

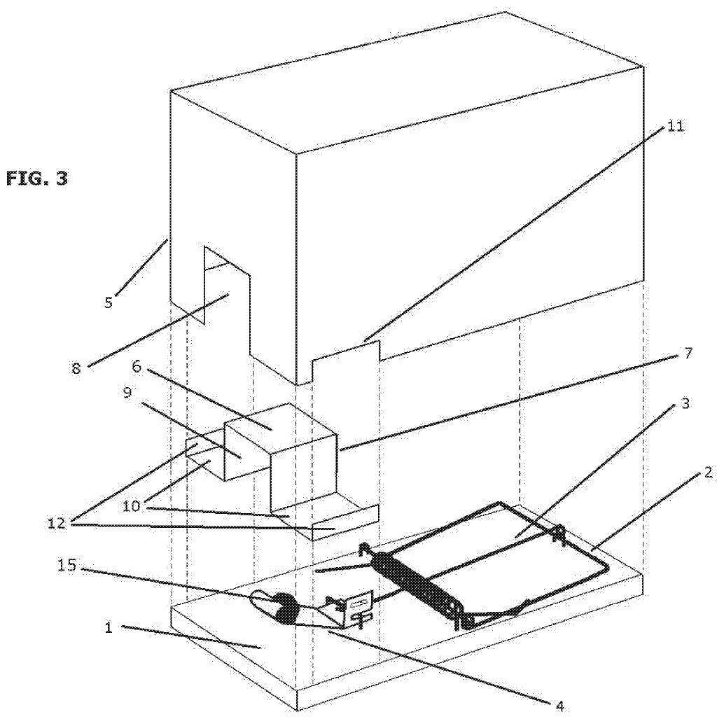

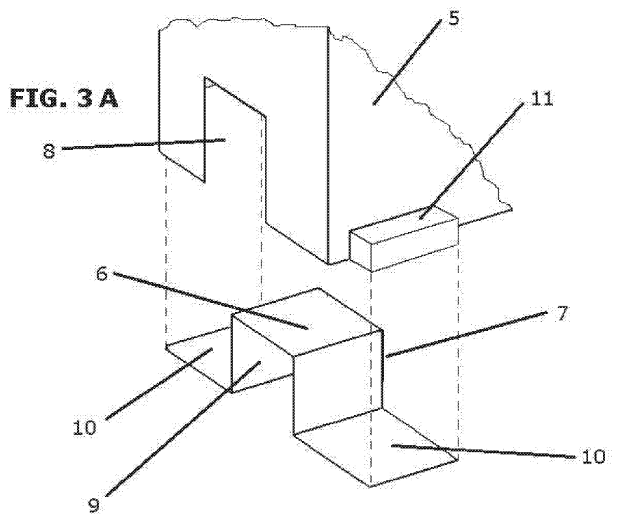

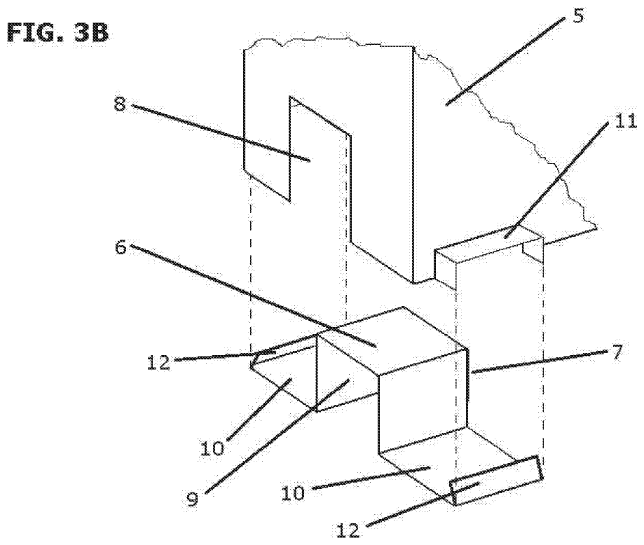

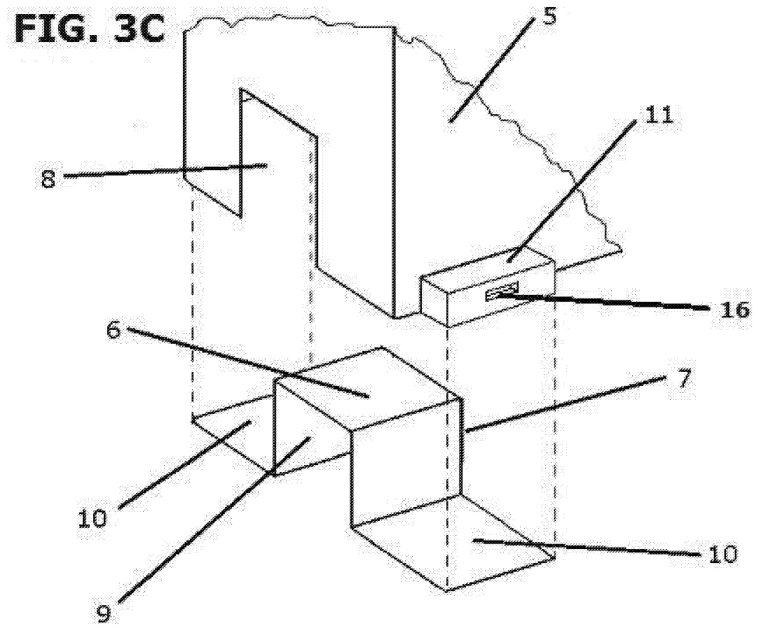

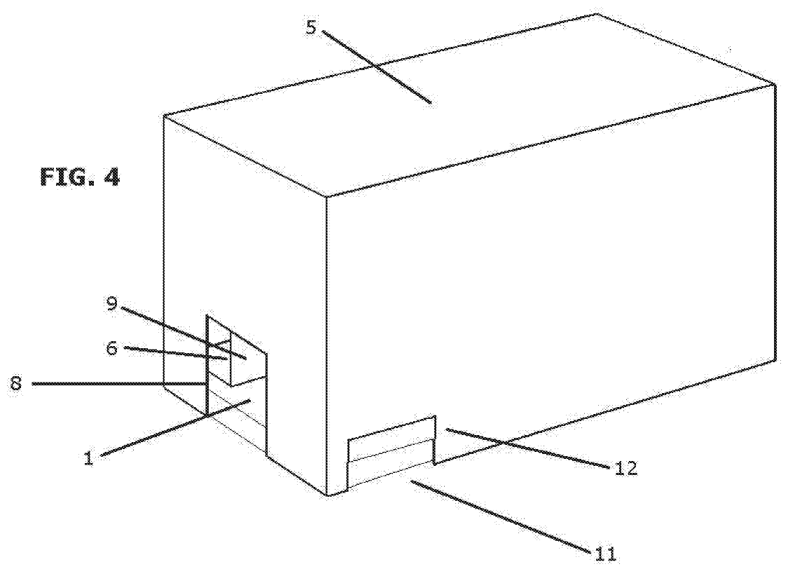

FIG. 2 shows the present disclosure. A trap 1 cover consists of an outer housing 5 and an inner housing 6 in conjunction with the trap 1 (see FIG. 3 and FIG. 4). A purpose of the outer housing 5 is to cover the trap 1 so the mouse (as shown) can only enter the housing through access opening 8, in such a way that its head is aligned with the trigger mechanism 4 thus positioning the head so the striking bar 2 will strike the mouse in the head or neck. A further purpose of the outer housing 5 is to prevent access to the trap 1 by pets or children.

The outer housing 5 can be made of plastic, metal, corrugated paper board or any structural material that is suitable for creating a housing structure. A preferred construction of the outer housing 5 would be a vacuum formed or a blow molded thin thermo plastic similar to the material used in a disposable plastic drinking cup or a blister used in packaging items for display. Another preferred construction is plastic inner housing 6 being injection molded.

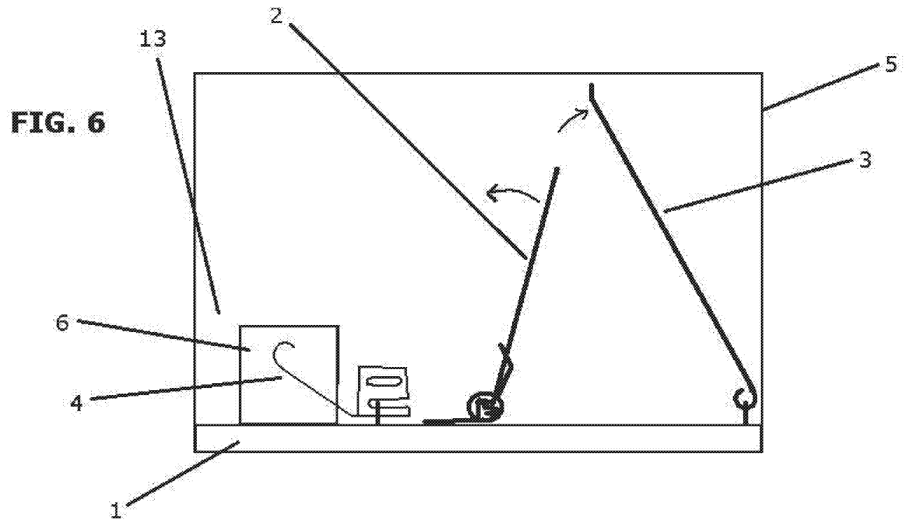

As shown in FIG. 3, the outer housing 5 consists of a box that is open on the bottom so that it fits over the wooden frame of the trap 1 (see FIG. 3 and FIG. 4) so that the trap 1 is completely enclosed. The outer housing 5 has an access opening 8 on the front that is big enough to let the mouse put its head in to get to the bait 15 on the trigger mechanism 4 (see FIG. 2 and FIG. 4). The opening is centered on the front end of the outer housing 5 (see FIG. 4) so that it aligns with the trigger mechanism 4 (see FIG. 1) that is holding the bait 15 thus causing the mouse to have its head or neck positioned under the center of the striking bar 2 when the mouse has its mouth on the baited trigger mechanism 4 (see FIG. 2). The outer housing 5 is tall enough to allow the retaining bar 3 to swing up when the trap 1 is triggered (see FIG. 6). A purpose of the inner housing 6 (see FIG. 3 and FIG. 4) is to prevent the mouse from advancing too far onto the trap 1 after entering the access opening in the outer housing 8. This forces the mouse to be in the correct position for the striking bar 2 to strike the mouse in the head or neck when the trap is triggered by the mouse engaging the bait 15 on the trigger mechanism 4.

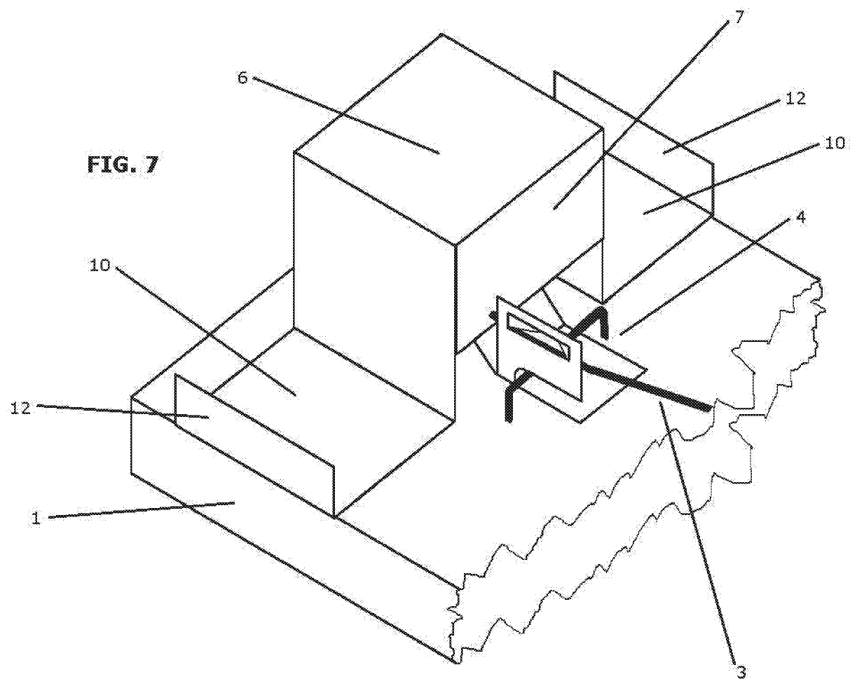

The inner housing 6 also serves several purposes valuable to the trap. A first is to shield the mouse from seeing the retaining bar 3 start to move when the trigger mechanism 4 is activated thus keeping the mouse from being startled and jumping back out of the trap 1 (see FIG. 2, and FIG. 7). Another purpose of the inner housing 6 is to restrict the access to the bait 15 so that the mouse must push its mouth between the top of the inner housing 6 and the part of the trigger mechanism 4 that holds the bait 15 causing the trigger mechanism 4 to be activated (see FIG. 2).

As with the outer housing, the inner housing 6 can be made from plastic, metal, cardboard or any material that is structurally suitable. The preferred material would be a sheet metal that can be formed by stamping on a progressive die.

The inner housing 6 is an enclosure that is open on the bottom to allow it to set over the trigger mechanism 4, and open in the front to allow the mouse to enter 9. The bottom of the side walls extend out at preferably a 90 degree angle to form tabs 10 that engage slots in the outer housing 5 which holds it in position when the outer housing 5 is in place over the trap 1 (see FIG. 3 and FIG. 4). The back wall 7 of the inner housing 6 extends part way down so that the outer housing 5 can fit over the trigger mechanism 4 without touching the trigger mechanism 4 (see FIG. 7).

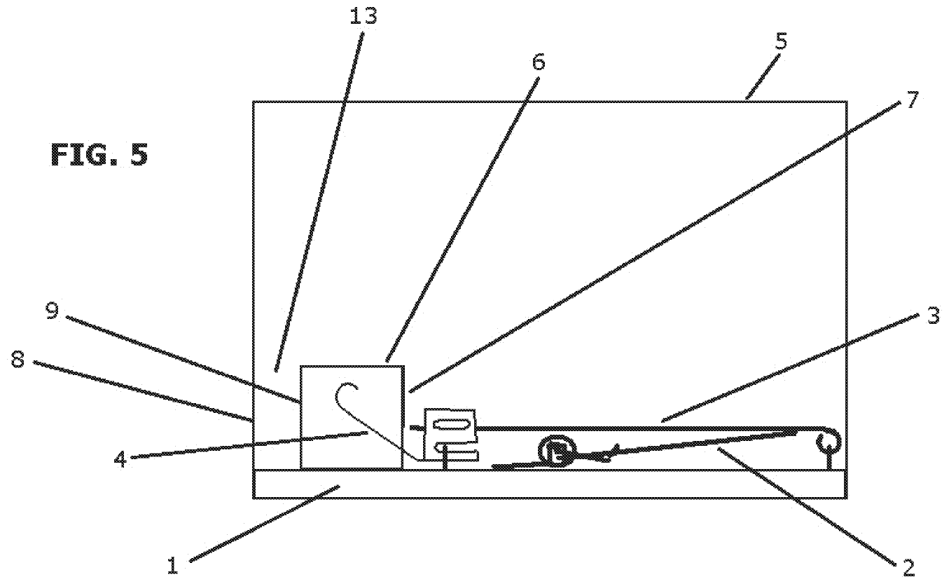

The inner housing 6 fits over the trigger mechanism 4 is such a way that the part of the trigger mechanism 4 that holds the bait 15 is covered by the inner housing 6 (see FIG. 7 and FIG. 3). A space 14 between the part of the trigger mechanism 4 that holds the bait 15 and the top part of the inner housing 6 interior is of sufficient size to cause the mouse to push its mouth into the space 14 to get at the bait 15 (see FIG. 2) thus activating the trigger mechanism 4 more reliably. The partial back wall 7 of the inner housing 6 extends down between the part of the trigger mechanism 4 that holds the bait 15 and the part of the trigger mechanism 4 that engages the retaining bar 3 thus preventing the mouse from seeing the retaining bar 3 move when the trigger mechanism 4 is activated (see FIG. 7, FIG. 2, FIG. 5 and FIG. 6).

Another aspect of the inner housing 6 is the access opening 9 that is aligned with, and is of approximately the same size as the access opening 8 in the outer housing 5. This allows the mouse to put its head through the access opening 8 in the outer housing 5 and through the access opening 9 in the inner housing 6 to access the bait 15 (see FIG. 4, FIG. 3 and FIG. 2). There is sufficient space 13 (see FIG. 2 and FIG. 5) between the inner housing access opening 9 and the outer housing access opening 8 (see FIG. 4, FIG. 3, FIG. 2 and FIG. 5) to allow the striking bar 2 to pass between the inner housing 6 and the outer housing 5 when the trigger mechanism 4 is activated (see FIG. 6).

It is preferably that the inner housing 6 is positioned precisely over the trigger mechanism 4 (see FIG. 5). The positioning is accomplished by tabs 10 that extend out from the bottom of each side of the inner housing 6 to engage notches or pockets 11 in the sides of the outer housing 5 (see FIG. 4, FIG. 3, FIG. 3A and FIG. 8). The inner housing 6 is fitted into the slots or pockets in the outer housing 5. The outer housing 5, with the inner housing 6 fitted to it, is then placed over the trap 1 after the trap 1 has been set. Because the outer housing 5 fits the wooden base of the trap 1 precisely this allows the inner housing 6 to be correctly positioned over the trigger mechanism 4.

The inner housing 6 is preferably held in place while the outer housing 5 is being lowered over the trap 1 by a tight fit in the pockets 11 in the outer housing 5 (see FIG. 3A). The total width of the inner housing 6, at the tabs 10 is preferably slightly bigger than the width of the outer housing 5 is at the inside of the pockets 11 so that the inner housing 6 will flex inward slightly and put tension on the inside of the pockets 11 to hold the inner housing 6 in place while it is being lowered onto the trap 1. An additional means of securing the inner housing 6 while it is being lowered into place over the trap 1 is to have securing tabs 12 (see FIG. 3) that extend upward from the ends of the positioning tabs 10 so that they can be held with the fingers to keep the inner housing 6 from falling out of the pockets 11 while it is being lowered onto the trap 1. An additional means of securing the inner housing 6 while it is being lowered into place over the trap 1 is to have securing tabs 12 (see FIG. 3B) that extend upward from the ends of the positioning tabs 10 and are bent inward. The pockets 11 extend out from the side of the outer housing 5 and are open at the ends. The inner housing 6 is flexed out slightly and the positioning tabs 10 are placed in the pockets 11 in such a way that the securing tabs 12 that are bent slightly inward, will fit over the top edge of the pocket 11 and be held in place by the spring tension of the inner housing 6 being flexed out slightly. As can be seen in FIG. 3c pocket 11 can preferably have notches or holes 16 which will hold tabs 10 in position. The tabs 10 are held in tension and snap into place in the holes 16. This ensures that when outer housing 5 presses onto the base of the mousetrap 1, it fits snugly. While these means have been discussed, many other suitable means for positioning and holding the inner housing 6 in place can be envisioned.

In order to ensure that the inner housing 6 is oriented properly in relation to the trap 1 and the outer housing 5, one of the positioning tabs 10 can be made smaller to fit into one of the positioning notches 11 that is also smaller so that the inner housing 6 will only fit in the outer housing 5 one way. When the trap 1 is set and the inner and outer housing 5 are secured in place over the trap 1, then the system is configured to catch mice efficiently, humanely and safely. The mouse can only access the bait 15 through the access opening 8 in the outer housing 5 so when the mouse is eating the bait 15, its head is positioned precisely so the striking bar 2 will hit the head or neck and kill the mouse instantly (see FIG. 2). The mouse cannot go inside the outer housing 5 past the bait 15 because it is blocked by the inner housing 6. This prevents the mouse from being hit by the striking bar 2 on any part of its body except the head or neck thus preventing injuries that would cause prolonged suffering and slow death for the mouse. The mouse cannot see the retaining bar 3 where it engages the trigger mechanism 4 because the partial back wall 7 of the inner housing 6 is blocking its view (see FIG. 7) so the mouse does not jump back when the trigger is activated and the retaining bar 3 starts to move up. This greatly reduces the chances that the mouse will escape from the trap 1 thus making the trap 1 much more efficient.

Finally, because the trap 1 is covered by the outer housing 5 the trap 1 cannot be accessed by pets or children so it is much safer then the trap 1 alone.

### Industrial Operation

In a preferred deployment, the trap 1 is baited on the top of the trigger mechanism 4 and set in the normal manner. The inner housing 6 is placed into the outer housing 5 so that the access opening in the inner housing 9 is facing the access opening in the outer housing 8 and the positioning tabs 10 are set into the positioning notches 11. The outer housing 5 is grabbed by the hand in such a way that the fingers are holding the securing tabs 12 while the outer housing 5 and the inner housing 6 are picked up thus keeping the inner housing 6 in place in the outer housing 5. The outer housing 5 with the inner housing 6 in place is then carefully lowered over the trap 1 in such a way that the inner housing 6 is covering the part of the trigger mechanism 4 that holds the bait 15 and the outer housing 5 pushes down to completely enclose the outer edges of the trap 1.

With the outer housing 5 and the inner housing 6 in place over the trap 1 the mouse can only access the baited trigger mechanism 4 through the access openings 8 and 9 so the head and neck are positioned exactly where the striking bar 2 will hit to kill the mouse instantly without suffering. Of particular note, the mouse cannot see the retaining bar 3 in this position so it is not startled when the retaining bar 3 starts to move when the trigger mechanism 4 is activated so the mouse is much less likely to escape the trap 1. The mouse must now force its nose into a space 14 between the trigger mechanism 4 and the top of the inner housing 6 to get at the bait 15 so it is much more likely to trigger the trap 1.

Thus, the present disclosure essentially contemplates a mousetrap apparatus composed of a trap 1, the trap having a base, a striking bar 2, a retaining bar 3, and a trigger 4, an inner housing 6 having an access opening 9, positioning tab 10 s, and securing tabs 12, and an outer housing 5 having an access opening, a pocket 11, and at least four walls, and preferably having a top. The access opening 8 of the outer housing 5 can be aligned with the access opening of the inner housing 9, and the access opening 8 of the outer housing can be centered on a front wall and aligned with the trigger 4 of the trap. The inner housing 6 can be positioned over the trigger 4 of the trap 1 and the access opening 9 has clearance allowing entry by a rodent. The positioning tabs can be aligned with the pocket 11 of positioning the inner housing within the outer housing and thus the positioning is secured by the securing tabs 12. The inner housing 6 may also have a back 7, the back partially covering one side of the access opening, narrowing the access opening on the side closest to the triggering mechanism 4. The front side of the access opening 9 is preferably large enough to allow entry by a rodent and the back side 7 of the access opening 9 is preferably large enough to allow the head of a rodent through and small enough to prevent exit by the rodent through that side (See FIG. 2). Bait 15 is placed on the trigger mechanism of the trap.

In a more simplified embodiment the disclosure contemplates a mousetrap cover composed of an outer housing 5 having a front wall, a back wall, and two side walls, an access opening 8 located centrally on the front wall, and positioning notches 11, and an inner housing 6 having an access opening 9, positioning tabs 10, and securing tabs 12, the access opening 9 of the inner housing 6 positioned within the access opening of the outer housing 5. The inner housing access opening 9 is defined by a left panel, a right panel, and a top panel and the positioning tabs 10 are connected to the left panel and the right panel. The inner housing access opening is further defined by a back wall 7, the back wall 7 partially narrowing the back side of the access opening. The positioning tabs are mated with the positioning notches. The access openings of the inner housing and outer housing are rectangular. The access openings of the inner housing 6 and outer housing 5 are capable of admitting a rodent.

Another way of utilizing the present disclosure is by a method of dispatching rodents. The method is made up of providing a trap 1, and inner housing 6 and an outer housing 5, the trap having a base, a striking bar 2, a retaining bar 3, and a trigger 4, the inner housing 6 having an access opening 9, positioning tabs 10, and securing tabs 12, and the outer housing 5 having an access opening 8, a pocket 11, and at least four walls, baiting the trap with a bait 15, positioning the inner housing 6 over the trigger 4, positioning the outer housing 5 over the inner housing 6 and trap 1, admitting a rodent through the access opening 8 of the outer housing into the access opening 9 of the inner housing, and triggering the trigger 4, causing the retaining bar 3 to move and the striking bar 2 to strike thereby dispatching the rodent. Further, the inner housing access opening 9 is defined by a left panel, a right panel, a top panel and a back wall 7, the back wall 7 partially narrowing the back side of the access opening and the positioning tabs 10 are connected to the left panel and the right panel. In most cases the rodent is incapable of exiting the back side of the inner housing access opening 9. In addition the method may entail positioning the rodent such that the striking bar 2 will hit the head or neck of the rodent and kill the rodent instantly.

Accordingly, although the invention has been described by reference to certain preferred and alternative embodiments, it is not intended that the novel arrangements be limited thereby, but that modifications thereof are intended to be included as falling within the broad scope and spirit of the foregoing disclosures and the appended drawings.

I claim:

1. A mousetrap apparatus comprising:
a trap, the trap having a base, a striking bar, a retaining bar, and a trigger;
an inner housing having an access opening, positioning tabs, and securing tabs; and
an outer housing having an access opening, a pocket, and at least four walls and a top.

2. The mousetrap apparatus of claim 1 wherein:
the access opening of the outer housing is aligned with the access opening of the inner housing, and the access opening of the outer housing is centered on a front wall and aligned with the trigger of the trap.

3. The mousetrap apparatus of claim 2 wherein:
the inner housing is positioned over the trigger of the trap and the access opening has clearance allowing entry by a rodent.

4. The mousetrap apparatus of claim 3 wherein:
the positioning tabs are aligned with the pocket of positioning the inner housing within the outer housing and the positioning is secured by the securing tabs.

5. The mousetrap apparatus of claim 4 wherein:
the inner housing further comprises a back, the back partially covering one side of the access opening, narrowing the access opening on the side closest to the triggering mechanism.

6. The mousetrap apparatus of claim 5 wherein:
the front side of the access opening is large enough to allow entry by a rodent and the back side of the access opening is large enough to allow the head of a rodent through and small enough to prevent exit by the rodent through that side.

7. The mousetrap apparatus of claim 6 further comprising:
bait placed on the trigger mechanism of the trap.

8. A mousetrap cover comprising:
an outer housing having a front wall, a back wall, and two side walls, an access opening located centrally on the front wall, and positioning notches; and
an inner housing having an access opening, positioning tabs, and securing tabs, the access opening of the inner housing positioned within the access opening of the outer housing.

9. The mousetrap cover of claim 8 wherein:
the inner housing access opening is defined by a left panel, a right panel, and a top panel; and
the positioning tabs are connected to the left panel and the right panel.

10. The mousetrap cover of claim 9 wherein:
the inner housing access opening is further defined by a back wall, the back wall partially narrowing the back side of the access opening.

11. The mousetrap cover of claim 10 wherein:
the positioning tabs are mated with the positioning notches.

12. The mousetrap cover of claim 11 wherein:
the access openings of the inner housing and outer housing are rectangular.

13. The mousetrap cover of claim 12 wherein:
the access openings of the inner housing and outer housing are capable of admitting a rodent.

14. A method of dispatching rodents comprising:
providing a trap, and inner housing and an outer housing, the trap having a base, a striking bar, a retaining bar, and a trigger, the inner housing having an access opening, positioning tabs, and securing tabs, and the outer housing having an access opening, a pocket, and at least four walls;
baiting the trap with a bait;
positioning the inner housing over the trigger;
positioning the outer housing over the inner housing and trap;
admitting a rodent through the access opening of the outer housing into the access opening of the inner housing; and
triggering the trigger, causing the retaining bar to move and the striking bar to strike thereby dispatching the rodent.

15. The method of claim 14 wherein:
the inner housing access opening is defined by a left panel, a right panel, a top panel and a back wall, the back wall partially narrowing the back side of the access opening; and
the positioning tabs are connected to the left panel and the right panel.

16. The method of claim 15 wherein:
the rodent is incapable of exiting the back side of the inner housing access opening.

17. The method of claim 16 further comprising:
positioning the rodent such that the striking bar will hit the head or neck of the rodent and kill the rodent instantly.
